(19) United States
(12) Patent Application Publication
(10) Pub. No.: US 2023/0297966 A1
(43) Pub. Date: Sep. 21, 2023

(54) BEING PARENTS

(71) Applicant: SAP SE, Walldorf (DE)

(72) Inventors: Cristina Antelo, Madrid (ES); Pilar Navarro, Madrid (ES); Ruben Cid, Madrid (ES); Jorge Perez, Madrid (ES); Ramon Abruna, Madrid (ES); Narkixe Pardo, North Yorkshire (GB); Teresa Castano, Madrid (ES); Chintan Mota, Woodside, CA (US); Taira Fernandez del Amo Amigo, Heidelberg (DE)

(21) Appl. No.: 17/695,349

(22) Filed: Mar. 15, 2022

(51) Int. Cl. G06Q 10/10

(52) U.S. Cl. CPC G06Q 10/1057; G06Q 10/1095

(57) ABSTRACT

Computer-readable media, methods, and systems are disclosed for providing resources to parents within a workplace environment. Resources may be compiled in one convenient location to minimize the computing resources necessary to provide parents with the parenting resources to enable a parenting journey which allows for a positive work-life balance. Resources may also be provided to managers and human resources business partners to better manage parents in the workforce.

### TECHNICAL FIELD

Embodiments generally relate to providing an improved computer system for user interaction, and more particularly to providing enhanced user interfaces and a computer system which minimize the network stress required to provide necessary resources to parents and expecting parents.

Parents and expecting parents in the workforce face a number of challenges. Working parents are required to process a large amount of information, complete tasks, and learn about responsibilities unique to the parent's specific situation. There is no standardized guidance for these parents at the workplace. Many companies do not provide the necessary policies and resources to parents. While some companies are starting to offer policies, playbooks, and benefits to support parents at the workplace, there is still a lack of a solution that can deliver customized guidance to users based on the needs of the parent at the specific time of the pregnancy. Oftentimes the useful resources are spread across a firm's intranet, requiring the parents to use substantial network resources to locate the correct information that may be relevant at a particular time. The difficulties in locating the relevant information often lead to parents emailing with human resources, using even further network resources.

Accordingly, what is needed are methods and systems for automatically providing parents with the necessary resources specific to their unique situation, thereby addressing the above-mentioned problems.

### SUMMARY

Disclosed embodiments of the present technology solve the above-mentioned problems by providing systems, methods, and computer-readable media for providing parents with all relevant information regarding pregnancy, childbirth, and child raising with regard to the workplace in one convenient interface. The interface may initially display or otherwise highlight the pregnancy resources most relevant to a parent's current situation. As a parent progresses through the pregnancy, from announcing the pregnancy at work to balancing work-life balance as a parent, the interface can continue to provide relevant resources. By providing parents with all of the necessary information and tailoring the highlighted resources to the resources most relevant to the parent given the parent's current situation, companies can reduce the amount of wasted computer resources spent searching for such pregnancy resources.

In some aspects, the techniques described herein relate to one or more non-transitory computer-readable media storing computer-executable instructions that, when executed by a processor, perform a method for providing resources for parents in a workplace, the method including: receiving, from a first user, a parenthood status; receiving user information from a human resources information system; receiving policy information from a management system; in response to receiving the parenthood status, user information, and policy information, providing a list of resources to the first user; receiving a resource selection from the first user; and providing the selected resource to the first user.

In some aspects, the techniques described herein relate to a non-transitory computer-readable media, wherein the parenthood status may be one or more of communication, pregnancy, childbirth, parental leave, back to work, and work-life balance.

In some aspects, the techniques described herein relate to a non-transitory computer-readable media, wherein the list of resources is selected in part based on a trained machine learning model to rank each resource of the list of resources for the first user.

In some aspects, the techniques described herein relate to a non-transitory computer-readable media, wherein the method further includes receiving a resource input from the first user; and saving the resource input within the human resource information system.

In some aspects, the techniques described herein relate to a non-transitory computer-readable media, wherein the resource input is an indication of an amount of leave the first user intends to take.

In some aspects, the techniques described herein relate to a non-transitory computer-readable media, wherein the selected resource is a salary calculator.

In some aspects, the techniques described herein relate to a non-transitory computer-readable media, wherein the selected resource permits the first user to schedule a meeting with a manager.

In some aspects, the techniques described herein relate to a method for method for providing resources for parents in a workplace, the method including: receiving, from a first user, a parenthood status; receiving user information from a human resources information system; receiving policy information from a management system; in response to receiving the parenthood status, user information, and policy information, providing a list of resources to the first user; receiving a resource selection from the first user; and providing the selected resource to the first user.

In some aspects, the techniques described herein relate to a method, wherein the parenthood status may be one or more of communication, pregnancy, childbirth, parental leave, back to work, and work-life balance.

In some aspects, the techniques described herein relate to a method, wherein the list of resources is selected in part based on a trained machine learning model to rank each resource of the list of resources for the first user.

In some aspects, the techniques described herein relate to a method, wherein the method further includes receiving a resource input from the first user; and saving the resource input within the human resource information system.

In some aspects, the techniques described herein relate to a method, wherein the resource input is an indication of an amount of leave the first user intends to take.

In some aspects, the techniques described herein relate to a method, wherein the selected resource is a salary calculator.

In some aspects, the techniques described herein relate to a method, wherein the selected resource permits the first user to schedule a meeting with a manager.

In some aspects, the techniques described herein relate to a system for providing resources for parents in a workplace, the system including: at least one processor; and at least one non-transitory memory storing computer executable instructions that when executed by the at least one processor cause the system to carry out actions including: receiving, from a first user, a parenthood status; receiving user information from a human resources information system; receiving policy information from a management system; in response to receiving the parenthood status, user information, and policy information, providing a list of resources to the first user; receiving a resource selection from the first user; and providing the selected resource to the first user.

In some aspects, the techniques described herein relate to a system, wherein the parenthood status may be one or more of communication, pregnancy, childbirth, parental leave, back to work, and work-life balance.

In some aspects, the techniques described herein relate to a system, wherein the list of resources is selected in part based on a trained machine learning model to rank each resource of the list of resources for the first user.

In some aspects, the techniques described herein relate to a system, wherein the actions further include receiving a resource input from the first user; and saving the resource input within the human resource information system.

In some aspects, the techniques described herein relate to a system, wherein the resource input is an indication of an amount of leave the first user intends to take.

In some aspects, the techniques described herein relate to a system, wherein the selected resource is a salary calculator.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present teachings will be apparent from the following detailed description of the embodiments and the accompanying drawing figures.

### BRIEF DESCRIPTION OF THE DRAWING FIGURES

Embodiments are described in detail below with reference to the attached drawing figures, wherein:

FIG. 1 is an exemplary login interface for implementing various aspects described herein;

FIG. 2A is an exemplary user interface depicting a view for a parent;

FIG. 2B is an exemplary user interface depicting a view for a human resource business partner;

FIG. 2C is an exemplary user interface depicting a view for a manager;

FIG. 3 is an exemplary flow diagram illustrating a method for displaying specific resources to parents;

FIG. 4. is an exemplary system diagram for some embodiments; and

FIG. 5 is a diagram illustrating a sample computing device architecture for implementing various aspects described herein.

The drawing figures do not limit the present teachings to the specific embodiments disclosed and described herein. The drawings are not necessarily to scale, emphasis instead being placed upon clearly illustrating the principles of the disclosure.

### DETAILED DESCRIPTION

The following detailed description of embodiments references the accompanying drawings that illustrate specific embodiments in which the present teachings can be practiced. The described embodiments are intended to illustrate aspects of the present teachings in sufficient detail to enable those skilled in the art to practice the present teachings. Other embodiments can be utilized, and changes can be made without departing from the claims. The following detailed description is, therefore, not to be taken in a limiting sense. The scope of embodiments is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments but is not necessarily included. Thus, the technology can include a variety of combinations and/or integrations of the embodiments described herein.

Embodiments are contemplated where a user is able to login to a system for parents or expecting parents which provides tailored resources including announcements, benefits, tasks, and information specific to the user's current status within the parenthood journey. Resources may be provided for a user at any point in the user's parenthood journey. A user may desire to access the system before the user announces to the company that a child is coming, for example if the user is thinking of having a child and wishes to learn more information. Users may continue to use the system once the user has a child and the user is balancing the requirements of both life and work. These resources may sync with a company's existing infrastructure to provide resources which are also specific to the company, the user's country and/or region, and the user's employment situation, in addition to the user's current parenthood journey status. By optimizing the resources available to a user and proactively providing those resources to the user, a company can minimize the network resources required to effectively manage working parents.

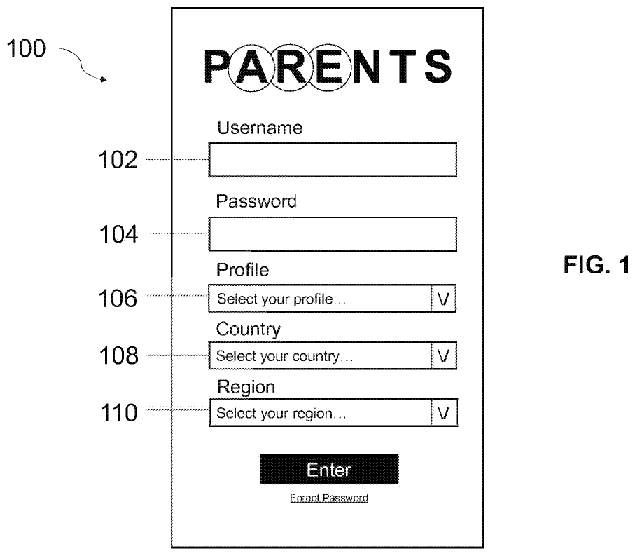

Turning first to FIG. 1, login interface 100 depicts an exemplary user interface for logging in to an online platform hosting the parenthood resources. Text box 102 provides a location for a user to enter the user's username, and text box 104 provides a location for a user to enter the user's password. In some embodiments, text box 102 and text box 104 may be replaced with a single sign on (SSO) solution, such as a corporate single sign on solution, allowing login interface 100 to be bypassed entirely. In further embodiments, login interface 100 may not be provided if a user has already logged in to a secure system, such as a human resources information system. For example, login interface 100 may be provided as a portal on the intranet which requires users to be authorized to access the intranet.

In some embodiments, selection box 106 may permit a user to select a profile. The selected profile may determine which content within the parent platform the user is able to see. Profile options may be mother, father, parent, manager, human resources business partner, or administrator. In some embodiments, the profile may be auto-populated based on the username provided. Mothers, fathers, and parents may be provided with the standard parenthood platform providing resources for parents. Managers may be provided with tools and resources for managing workers who are parents. Human resource business partners may be able to see hiring goals, including how the company is doing with regards to key performance indicators related to hiring and retention for parents. Administrators may be able to modify the parenthood platform to modify user data, update information related to the company's policies, and otherwise make changes as necessary to the parenthood platform.

In some embodiments, selection box 108 and selection box 110 may permit a user to select a country and region respectively. In further embodiments, a user may be able to select a country, state, and city. Selection box 108 and selection box 110 may be auto-populated based on the username entered into text box 102. For example, login interface 100 may sync with a human resources system comprising information on the location of every user at the company, and may automatically determine the user's country and region based on the existing information. Determining the correct location for each user may be important because some countries, states, regions, and cities have different laws and policies pertaining to the rights and benefits for working parents. For example, the United States may not require companies to offer any paid time off for maternity leave whereas Spain may require sixteen weeks for maternity leave. Companies may also have different policies based on the location which may differ from the legal minimum requirements.

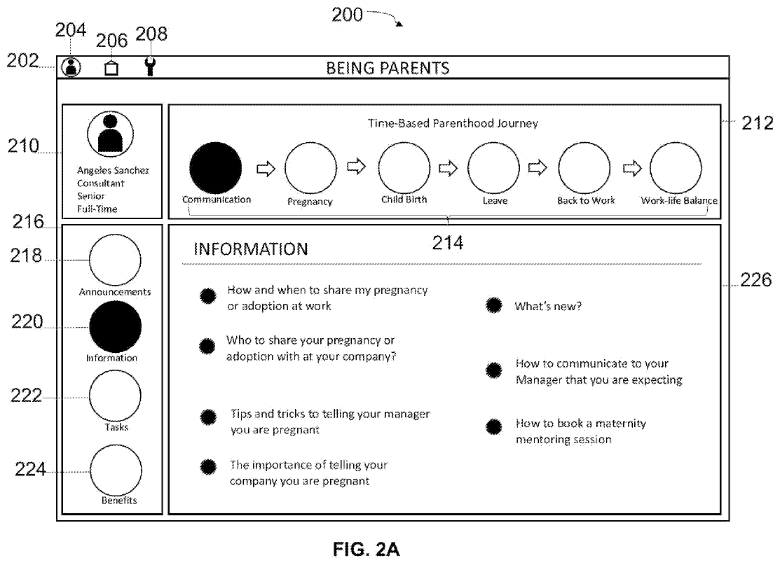

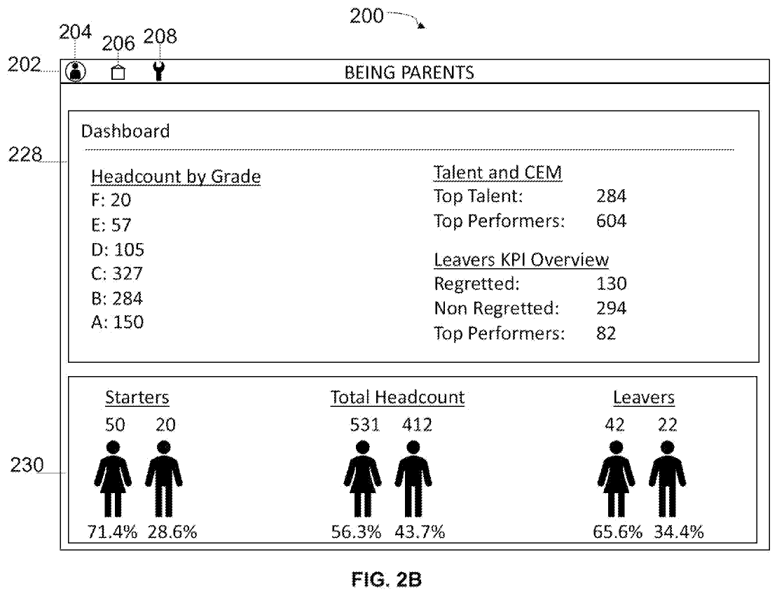

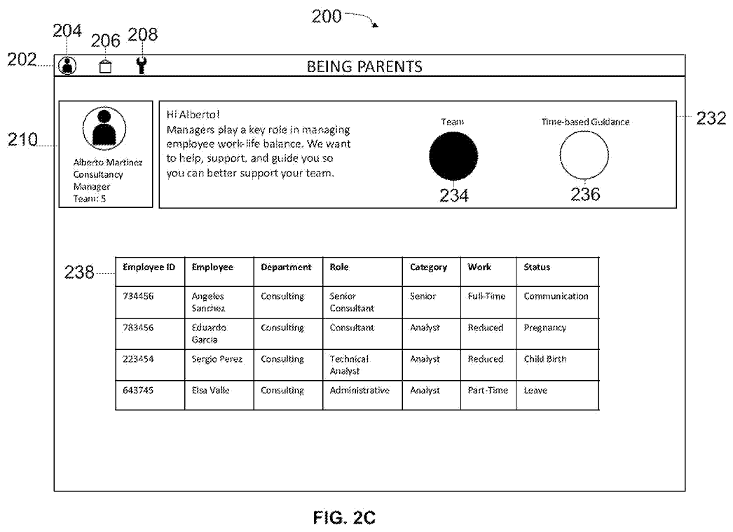

Turning now to FIG. 2A, user interface 200 depicts an exemplary interface for a parent. User interface 200 may be provided to a user upon logging in to the parenthood platform. The parenthood platform may comprise parent platform toolbar 202. Parent platform toolbar 202 may further comprise settings icon 204, home icon 206, and tools icon 208. Settings icon 204 may permit a user to change the settings related to either the user or the parenthood platform. In some embodiments, a user may be prompted for information on the user's parenthood journey status the first time the user accesses user interface 200. For example, a user may be asked to input a parenthood milestone that most closely matches the user's current situation. In some embodiments, a user may be able to modify the settings to indicate how many children they are expecting and what the arrival date is. For example, a mother may be pregnant with twins and enter this information into the system along with her due date. As another example, a father and his partner may be planning to adopt, and may input the adoption date into the system under the settings menu. In some embodiments, information entered into the settings may change the default view that a user is presented upon logging in to the parenthood platform. These default settings may be predetermined by a system administrator. In some embodiments, the parenthood platform may be a part of a larger software platform. For example, the parenthood platform may be a module added to an existing enterprise software package. Home icon 206 may enable a user to leave the parenthood platform and return to the more general software platform.

In some embodiments, tools icon 208 may allow users to access tools related to parenthood. For example, users may be able to access a salary calculator which can show the user how different types of leave or different working percentages will affect the user's take home salary. For example, a user may wish to return to work with reduced hours and only work 70% of the user's previous hours. The salary calculator may pull the user's salary information from a human resources system, calculate a new salary given the user's requested hours, and provide a new salary to the user. As another example, a tool may permit pregnant women to request designated parking spaces closer to an office to minimize the distance walked. As another example, a tool may help mothers who have recently returned to work locate breastfeeding stations located within the office, as well as allow the mothers to reserve these spaces. As yet another example, a tool may allow parents to coordinate with a company-run daycare service to manage interviews, drop-offs, and pick-ups. As an even further example, a tool may include a community platform which permits users to share experiences and ask and answer questions. In some embodiments, users of the community platform may be anonymous. In other embodiments, users of the community platform may be identified by the user's status within the parenthood journey, such as if the user is expecting, how many weeks pregnant the user is, or how many children the user has. The community platform may be organized into various parenthood topics such as the birth of a child, childcare, and product recommendations. The tools available within the parenthood portal may be configured by a system administrator.

User pane 210 depicts information about the user currently logged in to the parenthood portal. In some embodiments, user pane 210 may comprise a picture of the user, the user's name, the user's role or job title, the user's seniority, and the user's current working status such as part-time or full-time. In further embodiments, user pane 210 may include information related to the user's parenthood status, such as the number of kids, due dates, or other similar information. In some embodiments, this information may be auto-populated from a human resources system. In further embodiments, a user may be able to modify the user's information, such as the user's picture.

Milestone pane 212 may comprise milestones 214 which are indicative of a part of the parenthood journey. In some embodiments, milestones 214 may include different phases of parenthood such as communication, pregnancy, childbirth, leave, back to work, and work-life balance. In some embodiments, different milestones 214 may be used for different parenthood situations such as adopting, surrogacy, or twins. In further embodiments, milestones 214 may differ for parents with multiple kids such that multiple milestones are able to be selected simultaneously. Milestones 214 break up the parenthood journey into portions of time requiring unique information, tasks, and benefits. For example, during the communication phase, a user may be interested in best practices for announcing the pregnancy to coworkers and general information about how the company handles pregnancy. These requirements are different from, for example, a parent with an older child who has returned to working full time and is interested in how to best manage work-life balance. As another example, a parent who is looking to return to work may wish to begin the process and paperwork required to initiate the transition back into working. Milestones 214 therefore provide an easy way for parents or prospective parents to quickly identify relevant resources without requiring significant network queries to locate the resources that are actually relevant for a given time frame. In some embodiments, a user may freely navigate between different milestones 214. This may allow a user to see upcoming resources which are not yet relevant to the user. By prioritizing the resources most likely relevant to the user while still permitting the user to see the entire range of resources, network resources can be minimized while still allowing the user to have the full functionality of the parenthood platform should they desire to access it.

Resource pane 216 may comprise resources for parents to help with the parenthood journey. In some embodiments, resource pane 216 may comprise announcements icon 218, information icon 220, tasks icon 222, and benefits icon 224. Selecting an icon from resource pane 216 will cause the selected resources to appear in parent pane 226. The resources which appear in parent pane 226 will be determined in part based on both the selection of resource pane 216 and milestone pane 212. This allows for customized guidance for the user such that information, tasks, and benefits which are most relevant to the user are prioritized. For example, if a user selects the leave milestone 214 and benefits icon 224, parent pane 226 may display information related to the leave benefits, such as the amount of time the parent is able to take leave and still receive full pay. As another example, selecting pregnancy milestone 214 and tasks icon 222 may provide the user with a prompt to enter in time when the new child is expected such that the company can coordinate staffing needs in advance. Once the new child's expected due date is entered, the system may continue to prompt the user with additional tasks as the user progresses through the parenthood journey. In some embodiments, the selected milestone 214 and resource may be indicated by highlighting or otherwise modifying the icons to indicate the icon's selection. The resources provided in parent pane 226 may permit a user to select the resource to view additional information about the resource. In some embodiments, the resources in parent pane 226 may have text or a graphic associated with the resource.

Announcements icon 218 may provide a user with announcements relevant to parents, the company as a whole, or to the milestone 214 selected by the user. For example, an announcement may include that the country in which the user is a resident has recently passed a new law extending mandatory parental leave. As another example, an announcement may be that the company is considering investing in an on-site daycare center and is requesting feedback from parents. Announcements may also include technical announcements such as an indication that the parenthood platform may be offline for a number of hours for an upgrade.

Information icon 220 may provide a user with information related to the selected milestone 214. In some embodiments, information may include policy information related to the company or country. For example, information related to leave may include the minimum and maximum amount of time off a parent is permitted to take before returning to work. Information may also include articles relevant to being a parent at work. For example, information may include an article discussing tips and tricks for managing pregnancy while working. In some embodiments, the company may select which information is to be provided to users from a database of all possible information. Such selections may be made by a system administrator. Information may also include contacts within the company such as a human resource business partner, other parents who have indicated they would like to be contacted as mentors, or other employees designated by the company to help with the parenthood process.

Tasks icon 222 may provide a user with tasks specific to the currently selected milestone 214 or the current parenthood journey status of the user. In some embodiments, the tasks may be automatically generated from a human resources system based on an indication of the user's parenthood status. For example, a company may offer between 10 and 20 weeks of maternity leave. A task may be for the user to select how many weeks of maternity leave they intend to take. In some embodiments, the task to input an amount of maternity leave may be automatically sent to the user at an appropriate time. As another example, a user may wish to return to the office earlier than they had previously indicated. A task may be for the user currently on leave to submit a form indicating the date when the user would like to return to confirm the date or to allow the user to enter a new date if the user would like to extend the leave. In some embodiments, the tasks may automatically sync with the human resources system. This may allow information entered by the user to automatically be accessible within other human resource applications. Tasks may additionally be synchronized with existing workplace systems for managing employee tasks and work. For example, a task may include a work handover specific to the user involving transitioning the user's workload to one or more other users while the user is on leave. The user may be required to assign all outstanding work items to other users to ensure full coverage in the user's absence. Tasks may also help users set out-of-office messages as an automatic response to incoming emails to identify the new contact for incoming business. Tasks may additionally include setting up email forwarding to ensure continuity. In some embodiments, a user may be tasked with a survey to evaluate their experience throughout the parenthood journey. This information may be used by both managers and human resources personnel to evaluate a company's parenthood programs so that the company can better maintain a positive work life balance for its employees. Such survey data may be anonymized and aggregated such that the parent's privacy is protected while still allowing for useful input.

Benefits icon 224 may provide a user with the specific benefits relevant to the parenthood journey. For example, a user selecting benefits icon 224 may be able to view the user's insurance policy as it pertains to childbirth. This may provide the user with the knowledge that their health insurance will cover any procedures necessary for the pregnancy. As another example, benefits may include lactation services, childcare services, or legal services for parents. In some embodiments, benefits may include disability insurance or other insurance programs which may be particularly relevant to parents. Any benefits which a company offers which may have special significance may be included. In some embodiments, benefits may include specific parking locations, such as parking lots or parking spaces, which may be available to pregnant women. The system may enable a user to reserve a designated parking space or to order a new parking tag allowing the user to park in reserved spaces. In some embodiments, a system administrator may determine which company benefits should be highlighted for certain milestones 214.

FIG. 2B, by contrast, illustrates user interface 200 when the user is a human resource business partner. Where common features or elements are unchanged, they are not discussed separately from their description with respect to FIG. 2A. As illustrated, user pane 210, milestone pane 212, resource pane 216, and parent pane 226 have been replaced with human resources pane 228 and human resources gender pane 230. Both human resources pane 228 and human resources gender pane 230 provide resources for a user who is a human resources business partner to review key performance indicators related to the parenthood journey. In some embodiments, human resources pane 228 and human resources gender pane 230 may be combined into one cumulative pane. Data related to all employees of the company who are engaged with the parenthood program may be captured and formatted for easy display.

In some embodiments, human resources pane 228 may display information related to the employee headcount, employee inflows and outflows, and survey information from employees on the parenthood journey. Human resources pane 228 may be configured for individual users to display the statistics and data most relevant to the user's role. As another example, a user in charge of employee retention may be more concerned with how many employees were promoted, what the raises were for those employees, and how well the employees performed. Survey data may inform the users as to how well specific aspects of the company's parenthood programs are performing. For example, human resources pane 228 may display how many people who are going on parental leave intend on returning. In some embodiments, key performance indicators may include the birth rate, children rate, or other metrics related to maternity and paternity leave management. For example, metrics indicating the cost of loss of talent may inform human resources business partners as to how to best manage personnel.

In some embodiments, human resources gender pane 230 may display employee metrics broken down by gender. Parenthood journeys may impact different genders differently, leading to a less diverse workforce. Users may wish to directly compare disparities in gender. For example, users may wish to see the number of employees that joined and left in the last year broken down by gender. This can inform the company if they are not recruiting enough employees of a specific gender, or if a specific gender is leaving the workplace more than others. Users may use this information to inform human resources policies related to parenthood.

FIG. 2C, by contrast, illustrates user interface 200 when the user is a manager. Where common features or elements are unchanged, they are not discussed separately from their description with respect to FIGS. 2A and 2B. A manager's user interface may further comprise manager tools pane 232 and manager pane 238. In some embodiments, manager tools pane 232 may comprise team icon 234 and time-based guidance icon 236. Selecting either team icon 234 or time-based guidance icon 236 may change the content displayed in manager pane 238.

Team icon 234 may provide the manager with a list of all employees reporting to the manager within the organization. The employee list may include information for each employee such as the employee's ID, name, department, role, category, hours such as full-time or part time, and parenthood milestone status. This provides a summary of all employees who may be involved with the parenthood platform. In some embodiments, a manager may be able to schedule meetings and one-on-one sessions with team members to discuss the professional careers of the parent. For example, tools may be provided to facilitate the scheduling automatically. In some embodiments, a company may be able to automatically redistribute sales quotas from parents on leave to other members of the sales team.

Time-based guidance icon 236 may permit the manager to see additional information related to when people may be on leave or returning back to work. In some embodiments, a manager may see employee information related to the parenthood journey, such as when the employee is either leaving or returning from leave. Compiling this information in one location permits a manager to make decisions related to staffing and to forecast work assignments. In some embodiments, a timeline indicating the number of employees who will be out may be displayed. In further embodiments, a manager may be able to initiate workflows which facilitate the hiring of temporary or permanent workers to replace parents on leave. For example, an email may be automatically sent to human resources to initiate the hiring process. As another example, a manager may be presented with various replacement options including the steps necessary to recruit a current or new employee, depending on the position, to assist with the responsibilities of the user on leave.

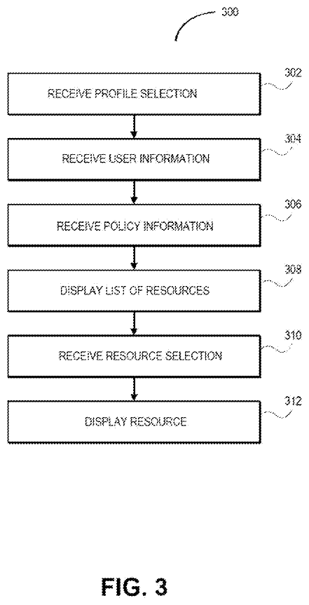

Turning now to FIG. 3, method 300 is depicted for displaying specific resources to parents. At step 302, a profile selection is received from a user. In some embodiments, the profile selection indicates whether the user is a parent, a manager, or a human resources business partner. In some embodiments, additional profiles may be provided such that the user can indicate further information, such as whether the user is a mother or father and the number of children the user has or is planning to have. The user's profile may determine which interface the user will be ultimately presented with. In some embodiments, the user's profile may be received from a login interface as depicted in FIG. 1.

At step 304, user information is received. In some embodiments, the user information may be provided by the user. For example, a prompt may request the user to select a milestone 214 corresponding to the user's status within a parenthood journey. As another example, upon initially logging in to the parenthood system the user may be prompted to input personal information. In further embodiments, user information may be provided from a human resources system. For example, the user's name, role, tile, and photograph may be loaded from an existing system containing employee information.

At step 306, policy information may be received. In some embodiments, the policy information may come from a document or content management system linked to the parenthood platform. Policy information may include policies specific to the company, such as the company's maternity leave policy including when the mother is allowed to take leave and for how long. In some embodiments, policy information may include policies specific to the region, such as statutes or laws passed which relate to parents at work. In addition to the policy information, in some embodiments additional parental resources may be provided.

At step 308, a list of resources may be displayed to the user. In some embodiments, the resources provided may include announcements, information, tasks, and benefits. The resources provided may be uniquely tailored to the user based on the combination of user information, user profile, and policy information. For example, a woman who is planning to take maternity leave soon may be provided with tasks related to leaving work. Additionally, the mother may be presented with policies specific to when she may be expected to return such that she can plan how long her leave should be. In some embodiments, the list of resources may include tools relevant to the parent's current position in the parenthood journey. The list of resources may be displayed as a grid. In some embodiments, the list of resources may be displayed based on an order of importance for the resource. In some embodiments, the order of the resources may be determined based on a machine learning model trained to predict the most significant resources based on the user's information, profile, and policy information.

At step 310, a selection of a resource may be received. In some embodiments, a user may select a resource by actuating an icon corresponding to the resource. For example, a user may use a mouse to actuate a resource link among the list of resources. In some embodiments, a user may select multiple resources at the same time. For example, a user may select multiple tasks at the same time such that the user can complete the multiple tasks at the same time.

At step 312, the selected resource may be displayed to the user. In some embodiments, the selected resource may be provided in a new tab within the platform. In further embodiments, the resource may be expanded from the list of resources such that the resource is visible within the list of resources. Once the resource is displayed, the user may interact with the resource depending on the type of resource. For example, a user may interact with a displayed article discussing best practices for new mothers returning to work. As another example, a user may interact with a thread within a community platform allowing users to share their own experiences in their maternity or paternity journey.

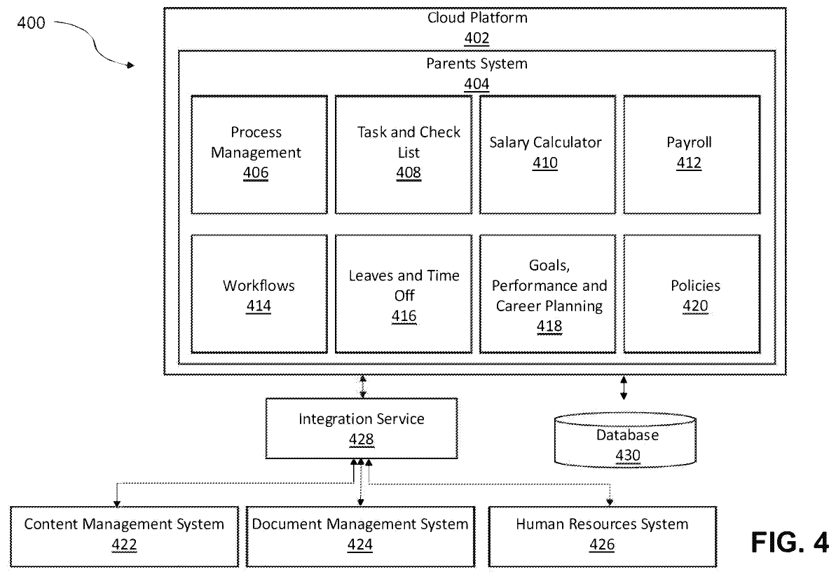

Turning now to FIG. 4, system 400 is depicted for providing cloud platform 402 for parents within a company. Cloud platform 402 may be an integrated system providing access to a variety of company resources to users via desktop computers, laptop computers, or mobile devices. In some embodiments, cloud platform 402 may be a platform as a service (PaaS). Cloud platform 402 may host parents system 404. Parents system 404 may comprise a variety of modules which provide resources for parents in the workplace. Parents system 404 may include resources such as process management 406, task- and checklist 408, salary calculator 410, payroll 412, workflows 414, leaves and time off 416, goals, performance, and career planning 418, and policies 420. In some embodiments, additional resources such as a recruitment platform and a community platform may be included. In further embodiments, cloud platform 402 may be connected to content management system 422, document management system 424, and human resources system 426 via integration service 428 and to database 430 for storing information. For example, a cloud based integration system may allow the platform to communicate with SAP JAM, SAP WORKZONE, and/or SAP SUCCESSFACTORS to provide the user with company and legal documents such as leave policies and goal setting protocols. In some embodiments, database 430 may be used to backup information for redundancy.

In some embodiments, process management 406 may comprise user interface 200 for managing the entire parenthood journey. In further embodiments, process management 406 may provide information for parents on the entire process of parenthood, from announcing pregnancy to returning back to work and managing work-life balance. Process management 406 may integrate with workflows 414 to provide users the ability to initiate parenthood related processes. In some embodiments, process management 406 may integrate with human resources system 426 to both provide data to the user and to permit the user to modify data and have it sync across the company. For example, a user may wish to set personal and professional goals with the human resources system 426. Goals, performance, and career planning 418 may provide a parent with prompts so they can enter goals. In some embodiments, a parent may be able to automatically set up meetings with a manager to discuss the goals.

In some embodiments, task- and checklist 408 may display a list of required tasks for the user to complete that correspond to the parenthood journey. For example, a user may have a task to complete paperwork related to time off. Leave and time off 416 may include resources related to both taking time off and returning back to work after the birth of a child. Salary calculator 410 may communicate with human resources system 426 to provide the user's current salary and show the user how the salary would change corresponding to different amounts of leave. For example, an analyst may wish to see how her salary would be affected by reducing to 70% of normal hours and salary calculator 410 could automatically provide this information based on the user inputting 70% as the desired hours. In some embodiments, salary calculator 410 may sync with payroll 412 such that the user's hours may be changed upon request by the user. In some embodiments, payroll 412 may also include information from the company's payroll system and/or time management system. In some embodiments, changes made in the parenting platform will not automatically be communicated to the payroll system, but rather must be transferred over by a human resources business partner.

In some embodiments, policies 420 may be available for access to the user. Policies 420 may be either company policies or region-specific policies on parental leave, pregnancy, or other parent-related issues in the workplace. In some embodiments, policies 420 may be stored in content management system 422 or document management system 424 and provided to the user as needed. Policies 420 may be static documents or may be dynamic documents which are updated by the company.

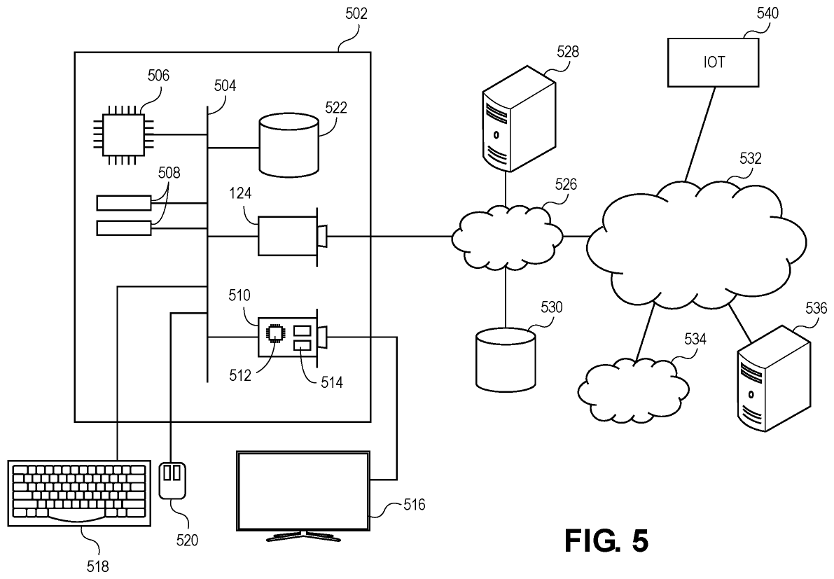

Turning now to FIG. 5, an exemplary hardware platform for certain embodiments is depicted. Computer 502 can be a desktop computer, a laptop computer, a server computer, a mobile device such as a smartphone or tablet, or any other form factor of general—or special-purpose computing device containing at least one processor. Depicted with computer 502 are several components, for illustrative purposes. In some embodiments, certain components may be arranged differently or absent. Additional components may also be present. Included in computer 502 is system bus 504, via which other components of computer 502 can communicate with each other. In certain embodiments, there may be multiple buses or components may communicate with each other directly. Connected to system bus 504 is central processing unit (CPU) 506. Also attached to system bus 504 are one or more random-access memory (RAM) modules 508. Also attached to system bus 504 is graphics card 510. In some embodiments, graphics card 510 may not be a physically separate card, but rather may be integrated into the motherboard or the CPU 506. In some embodiments, graphics card 510 has a separate graphics-processing unit (GPU) 512, which can be used for graphics processing or for general purpose computing (GPGPU). Also, on graphics card 510 is GPU memory 514. Connected (directly or indirectly) to graphics card 510 is display 516 for user interaction. In some embodiments no display is present, while in others it is integrated into computer 502. Similarly, peripherals such as keyboard 518 and mouse 520 are connected to system bus 504. Like display 516, these peripherals may be integrated into computer 502 or absent. Also connected to system bus 504 is local storage 522, which may be any form of computer-readable media, such as non-transitory computer readable media, and may be internally installed in computer 502 or externally and removably attached. Such non-transitory computer readable media may include transient memory such as RAM or other types of volatile computer readable media that do not persist stored information beyond a system shutdown or restart. It is understood that persistent storage (such as disk or solid state drive technology) is both non-transitory as well as non-transient, in that data stored in persistent storage persists data storage beyond a system restart.

Thus, non-transitory, computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 524 is also attached to system bus 504 and allows computer 502 to communicate over a network such as network 526. NIC 524 can be any form of network interface known in the art, such as Ethernet, ATM, fiber, Bluetooth, or Wi-Fi (i.e., the Institute of Electrical and Electronics Engineers (IEEE) 802.11 family of standards). NIC 524 connects computer 502 to local network 526, which may also include one or more other computers, such as computer 528, and network storage, such as data store 530. Generally, a data store such as data store 530 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 528, accessible on a local network such as local network 526, or remotely accessible over public Internet 532. Local network 526 is in turn connected to public Internet 532, which connects many networks such as local network 526, remote network 534 or directly attached computers such as computer 536. In some embodiments, computer 502 can itself be directly connected to public Internet 532.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “computer-readable medium” refers to any computer program product, apparatus and/or device, such as for example magnetic discs, optical disks, memory, and Programmable Logic Devices (PLDs), used to provide machine instructions and/or data to a programmable processor, including a computer-readable medium that receives machine instructions as a computer-readable signal. The term “computer-readable signal” refers to any signal used to provide machine instructions and/or data to a programmable processor. The computer-readable medium can store such machine instructions in a non-transitory manner, such as for example as would a non-transient solid-state memory or a magnetic hard drive or any equivalent storage medium. The computer-readable medium can alternatively or additionally store such machine instructions in a transient manner, for example as would a processor cache or other random-access memory associated with one or more physical processor cores.

Many different arrangements of the various components depicted, as well as components not shown, are possible without departing from the scope of the claims below. Embodiments have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims. Although the present teachings have been described with reference to the embodiments illustrated in the attached drawing figures, it is noted that equivalents may be employed and substitutions made herein without departing from the scope of the present teachings as recited in the claims.

Having thus described various embodiments, what is claimed as new and desired to be protected by Letters Patent includes the following:

1. One or more non-transitory computer-readable media storing computer-executable instructions that, when executed by a processor, perform a method for providing resources for parents in a workplace, the method comprising:
receiving, from a first user, a parenthood status;
receiving user information from a human resources information system;
receiving policy information from a management system;
in response to receiving the parenthood status, user information, and policy information, providing a list of resources to the first user;
receiving a resource selection from the first user; and
providing the selected resource to the first user.

2. The non-transitory computer-readable media of claim 1, wherein the parenthood status may be one or more of communication, pregnancy, childbirth, parental leave, back to work, and work-life balance.

3. The non-transitory computer-readable media of claim 1, wherein the list of resources is selected in part based on a trained machine learning model to rank each resource of the list of resources for the first user.

4. The non-transitory computer-readable media of claim 1, wherein the method further comprises:
receiving a resource input from the first user; and
saving the resource input within the human resource information system.

5. The non-transitory computer-readable media of claim 4, wherein the resource input is an indication of an amount of leave the first user intends to take.

6. The non-transitory computer-readable media of claim 1, wherein the selected resource is a salary calculator.

7. The non-transitory computer-readable media of claim 1, wherein the selected resource permits the first user to schedule a meeting with a manager.

8. A method for method for providing resources for parents in a workplace, the method comprising:
receiving, from a first user, a parenthood status;
receiving user information from a human resources information system;
receiving policy information from a management system;
in response to receiving the parenthood status, user information, and policy information, providing a list of resources to the first user;
receiving a resource selection from the first user; and
providing the selected resource to the first user.

9. The method of claim 8, wherein the parenthood status may be one or more of communication, pregnancy, childbirth, parental leave, back to work, and work-life balance.

10. The method of claim 8, wherein the list of resources is selected in part based on a trained machine learning model to rank each resource of the list of resources for the first user.

11. The method of claim 8, wherein the method further comprises:
receiving a resource input from the first user; and
saving the resource input within the human resource information system.

12. The method of claim 11, wherein the resource input is an indication of an amount of leave the first user intends to take.

13. The method of claim 8, wherein the selected resource is a salary calculator.

14. The method of claim 8, wherein the selected resource permits the first user to schedule a meeting with a manager.

15. A system for providing resources for parents in a workplace, the system comprising:
at least one processor;
and at least one non-transitory memory storing computer executable instructions that when executed by the at least one processor cause the system to carry out actions comprising:
receiving, from a first user, a parenthood status;
receiving user information from a human resources information system;
receiving policy information from a management system;
in response to receiving the parenthood status, user information, and policy information, providing a list of resources to the first user;
receiving a resource selection from the first user; and
providing the selected resource to the first user.

16. The system of claim 15, wherein the parenthood status may be one or more of communication, pregnancy, childbirth, parental leave, back to work, and work-life balance.

17. The system of claim 15, wherein the list of resources is selected in part based on a trained machine learning model to rank each resource of the list of resources for the first user.

18. The system of claim 15, wherein the actions further comprise:
receiving a resource input from the first user; and
saving the resource input within the human resource information system.

19. The system of claim 18, wherein the resource input is an indication of an amount of leave the first user intends to take.

20. The system of claim 15, wherein the selected resource is a salary calculator.
